(19) United States
(12) Patent Application Publication
(10) Pub. No.: US 2014/0160032 A1
(43) Pub. Date: Jun. 12, 2014

(54) Swipe Stroke Input and Continuous Handwriting

(71) Applicant: MICROSOFT CORPORATION, Redmond, WA (US)

(72) Inventors: Chiwei Che, Beijing (CN); Byron Huntley Changuion, Bellevue, WA (US); Qi Chen, Beijing (CN); Xiaoling Zhen, Beijing (CN); Xi Chen, Beijing (CN); Huihua Hou, Beijing (CN)

(73) Assignee: MICROSOFT CORPORATION, Redmond, WA (US)

(21) Appl. No.: 13/708,227

(22) Filed: Dec. 7, 2012

(51) Int. Cl. G06F 3/01

(52) U.S. Cl. CPC G06F 3/018
USPC 345/173

(57) ABSTRACT

Swipe-stroke input and continuous handwriting are provided. A stroke sequence or a portion of a stroke sequence of a Chinese character may be input via selecting one or more stroke buttons via a swipe gesture. Candidate characters may be determined and provided when an indication is received that a stroke sequence input has ended. A candidate may be selected, or a next stroke sequence may be input. As additional input is received, phrase candidates may be predicted and dynamically provided. An end-of-input (EOI) panel may be provided, which when selected, provides an indication of an end of a current handwriting input and allowing a next handwriting input to be entered. By providing a selectable functionality to indicate an end of a current handwriting input, a continuous and more efficient handwriting experience is provided. Past handwriting input may be stored and accessed, allowing a user to edit the past handwriting input.

### BACKGROUND

The Wubihua method or the five-stroke input method is a method currently used for inputting Chinese text on a computer based on the stroke sequence of a character. Physical buttons (e.g., on a keyboard) or soft input buttons displayed on a touchscreen may be assigned a specific stroke. Currently, a tap-to-input method is utilized to select a stroke sequence of a Chinese character. Current input methods do not leverage the advantage of a touchscreen or gesture input. A swipe-stroke input may provide users with a more comfortable and efficient input experience to input Chinese text.

A current method for Chinese handwriting input includes drawing a Chinese character via an input device, wherein a handwriting engine is operable to receive and recognize the handwriting input as a character. A limitation to this approach is that after a user enters a handwriting input, a delay is experienced while the handwriting engine determines if the handwriting input has been completed or if the user may be providing addition input. While current Chinese handwriting engines provide a high recognition rate, the delay may be frustrating to users who desire a continuous handwriting experience.

It is with respect to these and other considerations that the present invention has been made.

### SUMMARY

Embodiments of the present invention solve the above and other problems by providing swipe-stroke input and continuous handwriting. According to embodiments, a user interface may be provided for allowing a user to input a stroke sequence or a portion of a stroke sequence of a Chinese character via a swipe gesture. When a stroke sequence input is ended (e.g., when the user lifts his finger from the user interface), one or more candidates may be provided. The user may select a candidate or may continue to input a next stroke sequence. As additional input is received, phrase candidates may be predicted and provided. Swipe-stroke input may provide an improved and more efficient input experience.

According to embodiments, an “end-of-input” (EOI) panel may be provided, which when selected, provides an indication of an end of a current handwriting input. By selecting the EOI panel, a next handwriting input may be received, providing a continuous and more efficient handwriting experience. Embodiments may also store a past handwriting input. A past handwriting input may be provided in a recognized character panel, which when selected, allows a user to edit the past handwriting input.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is an illustration of an example current user interface design of stroke inputs disposed on keyboard buttons for a tap-to-input method;

FIG. 2 is an illustration of a graphical user interface comprising stroke buttons for providing swipe-stroke input;

FIG. 3 is a flow chart of a method for providing swipe-stroke input;

FIG. 4 is an illustration of receiving a stroke sequence input;

FIG. 5 is an illustration of a stroke sequence displayed in a message bar;

FIG. 6 is an illustration of receiving a second stroke sequence input;

FIG. 7 is an illustration of phrase candidates;

FIG. 8 is an illustration of a selected phrase candidate;

FIG. 9 is an illustration of a handwriting input in a writing panel;

FIG. 10 is a flow chart of a method for providing continuous handwriting;

FIG. 11 is an illustration of receiving handwriting input;

FIG. 12 is an illustration of a recognized character and candidates;

FIG. 13 is an illustration of a selection of an end-of-input panel;

FIG. 14 is an illustration of a selection of a recognized character;

FIG. 15 is an illustration of a selection of a character candidate;

FIG. 16 is an illustration of the selected character candidate displayed in the message bar and in the recognized character panel;

FIG. 17 is an illustration of receiving additional handwriting input;

FIG. 18 is a block diagram illustrating example physical components of a computing device with which embodiments of the invention may be practiced;

FIGS. 19A and 19B are simplified block diagrams of a mobile computing device with which embodiments of the present invention may be practiced; and

FIG. 20 is a simplified block diagram of a distributed computing system in which embodiments of the present invention may be practiced.

### DETAILED DESCRIPTION

As briefly described above, embodiments of the present invention are directed to providing swipe-stroke input and continuous handwriting. According to embodiments, stroke buttons may be provided, wherein a user may input a stroke sequence or a portion of a stroke sequence of a Chinese character via selecting one or more stroke buttons via a swipe gesture. One or more candidates may be determined and provided when a stroke sequence input is ended (e.g., when the user lifts his finger from the user interface). The user may select a candidate or may continue to input a next stroke sequence. Multiple characters or phrases may share the same stroke sequence. As additional input is received, phrase candidates may be predicted and dynamically provided.

Embodiments may also provide continuous handwriting for a faster stroke input method. According to embodiments, an “end-of-input” (EOI) panel may be provided. When the EOI panel is selected, an indication of an end of a current handwriting input may be received, and a next handwriting input may be entered. As described above, with current systems, the indication of an end of a current handwriting input is a timeout between handwriting inputs. By providing a selectable functionality to indicate an end of a current handwriting input, a continuous and more efficient handwriting experience may be provided. Embodiments may also store a past handwriting input, allowing a user to edit the past handwriting input.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

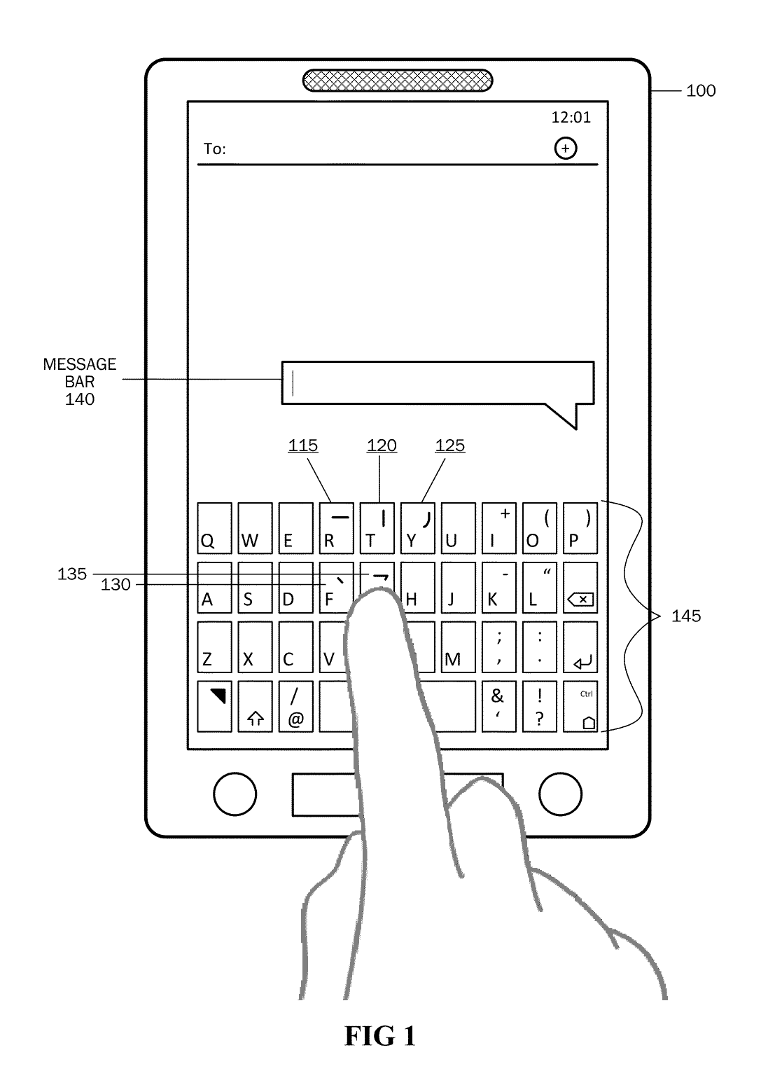

Referring now to the drawings, in which like numerals represent like elements, various embodiments will be described. Referring now to FIG. 1, an example of a current graphical user interface (GUI) design for inputting Chinese characters via a tap-to-input method is illustrated. The example GUI design is shown displayed on a mobile computing device 100 and comprises a plurality of keyboard keys 145, which may include soft keys or physical buttons. As illustrated, five keys 115,120,125,130,135 may be assigned a certain type of stroke. For example, the keys may include a horizontal stroke key 115, a vertical stroke key 120, a downwards right-to-left stroke key 125, a dot or downwards left-to-right stroke key 130, and an all-others stroke key 135. According to a current tap-to-input method, to input a Chinese character, a user may press the keys 115,120,125,130,135 corresponding to the strokes of the character in the stroke order of the character. An option may be provided for allowing a user to input the first several strokes of a character and providing a list of matching characters from which the user may choose the intended character. As described briefly above, this tap-to-input method does not leverage the advantage of a touchscreen interface.

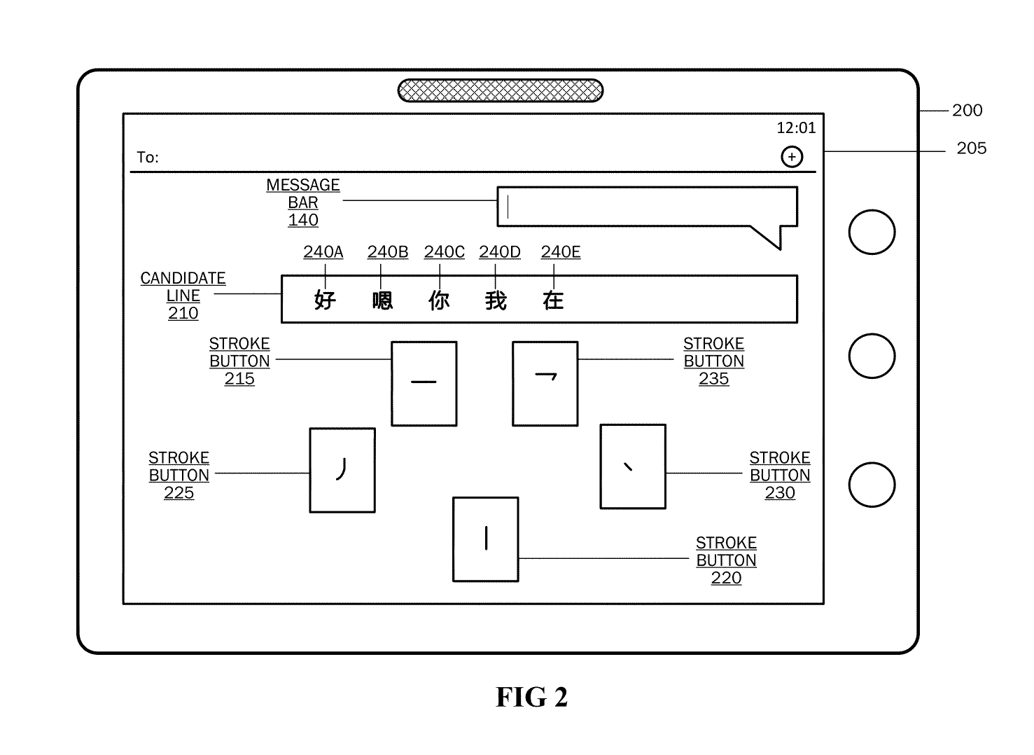

Referring now to FIG. 2, embodiments of the present invention provide a GUI comprising stroke buttons 215,220,225,230,235 displayed on a display interface 205 for allowing swipe-stroke input of Chinese characters. According to embodiments, the interface 205 may comprise various types of electronic visual display systems that are operable to detect the presence and location of a touch input (e.g., via a finger, hand, or passive object) or gesture input (e.g., bodily motion) within a display area. According to embodiments, swipe-stroke input may allow for faster character input, providing improved typing productivity. Embodiments may utilize a touch keyboard soft input panel (SIP) or an on-screen keyboard for providing a swipe-stroke input user interface (UI). The swipe-stroke input UI is shown displayed on a tablet computing device 200. As illustrated in FIG. 2, the stroke buttons 215,220,225,230,235 may be displayed in a circular configuration, allowing a user to input a stroke sequence by swiping his finger or other input device over one or more stroke buttons in stroke order of a character. The user may complete a stroke sequence input by lifting his finger or input device.

The swipe-stroke input UI may comprise a candidate line 210, as illustrated in FIG. 2, for displaying one or more predicted candidates 240, which may include predicted characters, words, and/or phrases according to received input and one or more prediction models. The swipe-stroke input UI may also comprise a message bar 140 for displaying one or more received stroke sequences. For example, upon selection of a stroke button 215,220,225,230,235, the associated character stroke may be displayed in the message bar 140. Additionally, upon recognition of a character or upon selection of a candidate 240 character, word, or phrase from the candidate line 210, the recognized/selected character, word, or phrase may be displayed in the message bar 140.

According to embodiments, a stroke sequence of a character may be a complete stroke sequence of a character or may be a portion of a stroke sequence of a character. Candidates 240 may be provided according to a received stroke sequence. As additional stroke sequences are received, candidates 240 may be dynamically updated.

Embodiments of the present invention may be applied to various software applications and may be utilized with various input methods. For example, embodiments are illustrated as applied to a messaging application; however, embodiments may be applied to various types of software applications where Chinese text may be input via a five-stroke input method (sometimes referred to as the Wubihua method).

Although the examples illustrated in the figures show touchscreen UIs on mobile 100 and tablet 200 devices, embodiments may be utilized on a vast array of devices including, but not limited to, desktop computer systems, wired and wireless computing systems, mobile computing systems (e.g., mobile telephones, netbooks, tablet or slate type computers, notebook computers, and laptop computers), hand-held devices, IP telephones, gaming devices, cameras, multiprocessor systems, microprocessor-based or programmable consumer electronics, minicomputers, and mainframe computers.

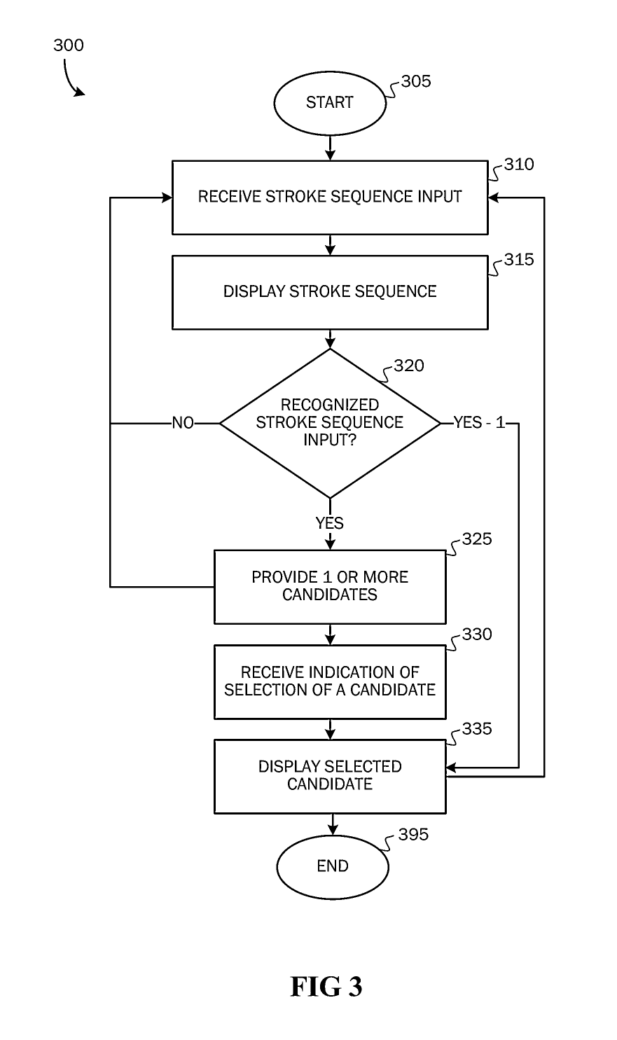

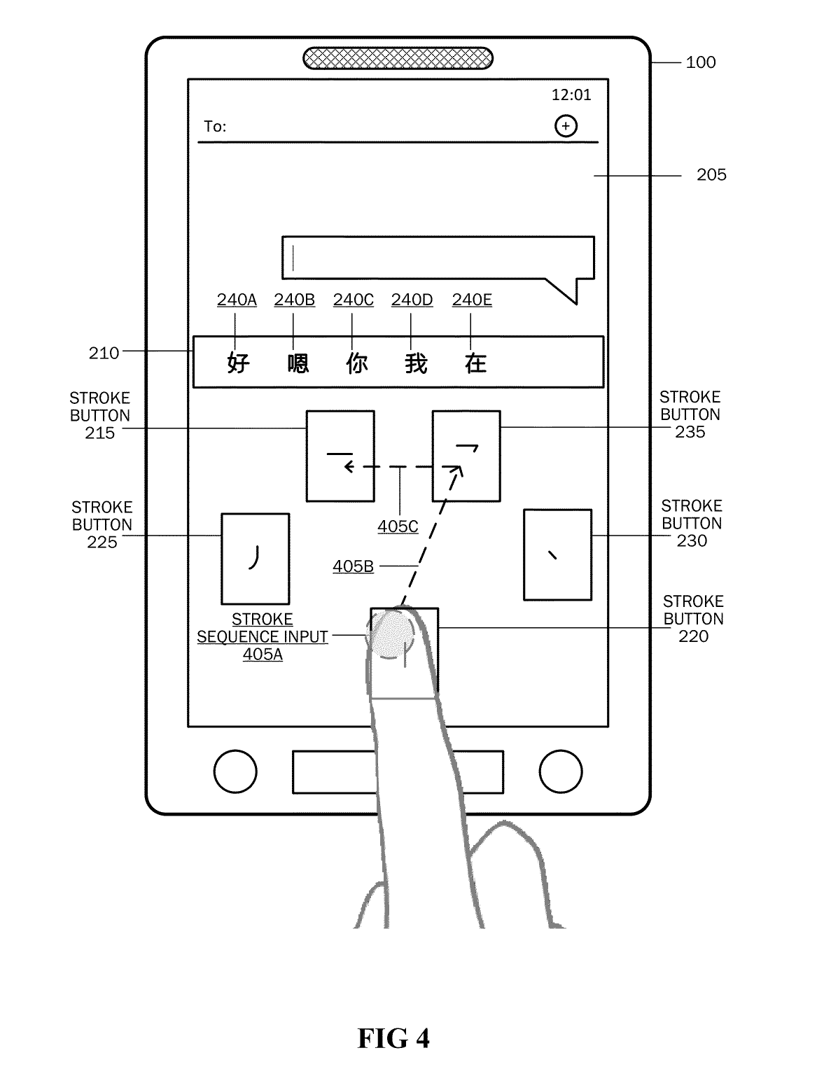

With reference now to FIG. 3, a flow chart of a method 300 for providing a swipe-stroke input for Chinese characters is illustrated. For purposes of illustration, the process flow of method 300 will be described with reference to FIGS. 4-8. The method 300 starts at OPERATION 305 and proceeds to OPERATION 310 where a stroke sequence input is received. An example stroke sequence input 405 is illustrated in FIG. 4. Receiving a stroke sequence input 405 (OPERATION 310) may include receiving an indication of a selection of a first stroke button 215,220,225,230,235. Receiving a stroke sequence input 405 (OPERATION 310) may continue as a user swipes his finger or other input device from the first stroke button to a next stroke button 215,220,225,230,235 to input a next stroke in a stroke sequence of a character. The stroke sequence input 405 may continue as the user continues to swipe his finger or other input device over one or more stroke buttons 215,220,225,230,235 in stroke order of a character, and may be completed upon receiving an indication of the user's finger or input device lifting from the touchscreen interface 205.

According to embodiments, a stroke sequence input 405 may comprise a portion of a stroke sequence of a character, for example, the first couple of strokes of a character. As can be appreciated, some Chinese characters may include many strokes. Embodiments allow a user to input a portion of a stroke sequence of a character via a stroke or swipe gesture, and thereby providing a faster stroke input. The example stroke sequence input 405 illustrated in FIG. 4 includes a selection of the vertical stroke button 220 (405A), followed by a swipe stroke input to the all-other stroke button 235 (405B), and followed by a swipe stroke input to the horizontal swipe button 215 (405C).

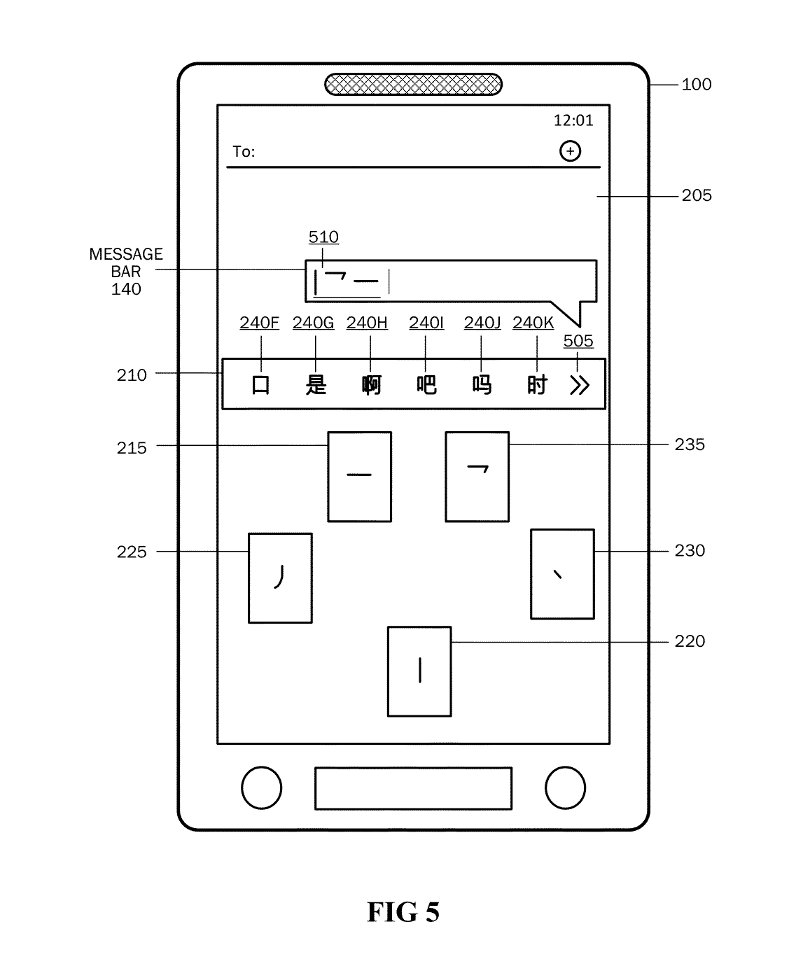

The method 300 proceeds to OPERATION 315, where the received stroke sequence input 405 may be displayed. An example stroke sequence 510 displayed in a message bar 140 is illustrated in FIG. 5. According to embodiments, upon receiving a stroke sequence input 405, each received input may be displayed as a stroke sequence 510. The stroke sequence 510 may be displayed in the message bar 140 as illustrated in FIG. 5.

Referring back to FIG. 3, the method 300 proceeds to DECISION OPERATION 320, where a determination may be made whether the received stroke sequence input 405 is recognized. That is, a determination is made whether a character or phrase may be predicted from a portion of the received stroke sequence input 405 or if a character or phrase may be determined from a complete stroke sequence input 405. If the received stroke sequence input 405 is not recognized, the method 300 may return to OPERATION 310 where additional stroke sequence input 405 is received.

If the received stroke sequence input 405 is recognized as a complete or partial stroke sequence 510 of a character or phrase, the method 300 may proceed to OPERATION 325, where one or more candidates may be provided. The one or more candidates 240 may be provided in the candidate line 210, for example, as illustrated in FIGS. 2, 4, 5, 6 and 7. A candidate 240 may include a character or phrase candidate 240.

According to the example illustrated in FIG. 5, the received stroke sequence input 405 (405A-C) is determined to be a stroke sequence 510 of a vertical stroke, followed by an all-other stroke, followed by a horizontal stroke. Accordingly, one or more characters and/or phrases that have been predicted from the stroke sequence 510 or a portion of the stroke sequence 510 may be provided as candidates 240 in the candidate line 210 from which a user may select. For example, the character “□” 240F may be determined to be one of one or more candidates 240 because the stroke sequence 510 to write the character “□” matches the received stroke sequence input 405. A functionality control, such as a scroll arrow 505, may be provided to scroll through additional candidates 240.

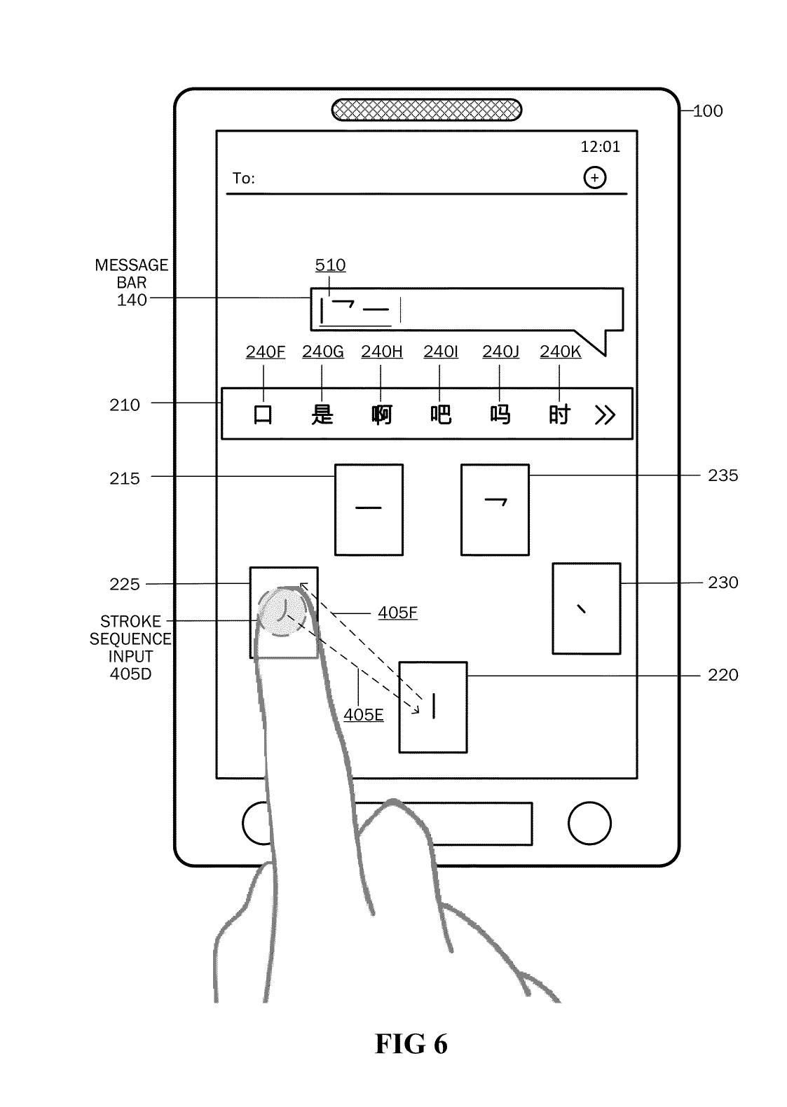

Referring again to FIG. 3, the method 300 may return to OPERATION 310 where another stroke sequence input 405 is received. According to embodiments, additional stroke sequence inputs 405 may be received before receiving a selection of a candidate 240. For example, as illustrated in FIG. 6, a second stroke sequence input 405 comprising a selection of the downwards right-to-left stroke button 225 (405D), followed by a swipe gesture to the vertical stroke button 220 (405E), and followed by a swipe gesture back to the downwards right-to-left stroke button 225 (405F) may be received (OPERATION 310). Accordingly, the stroke sequence 510 may be provided in the message bar 140 (OPERATION 315) after the first stroke sequence.

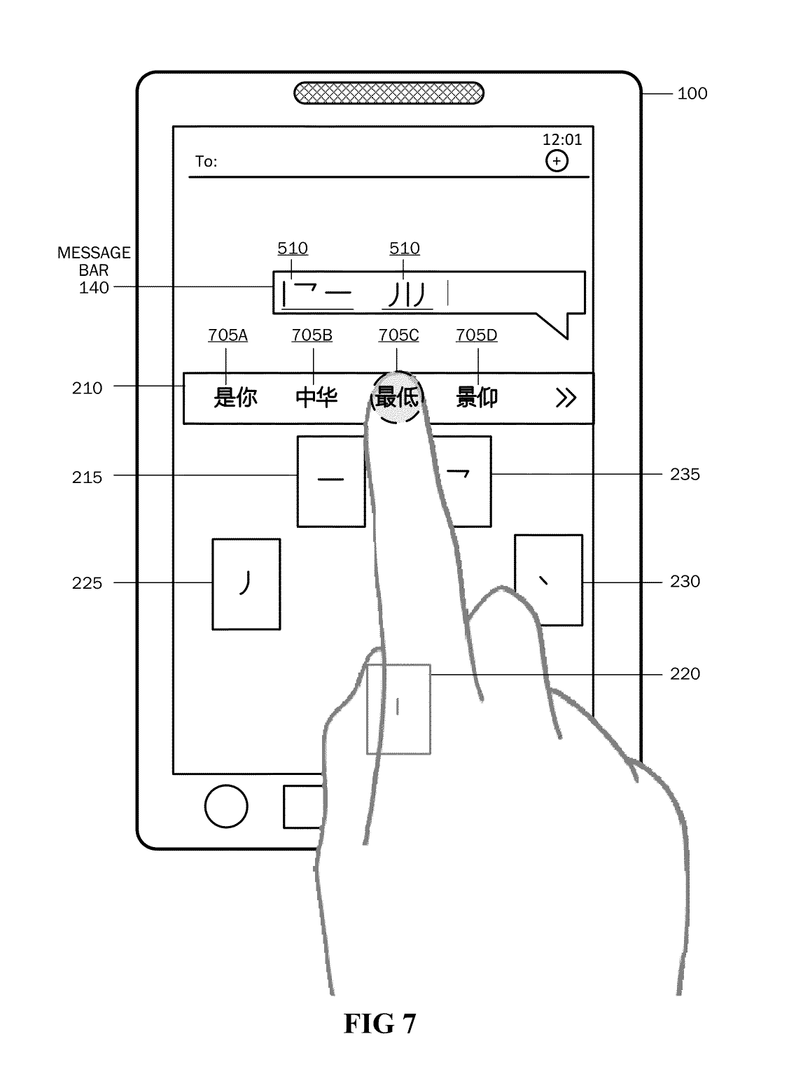

A determination may be made at DECISION OPERATION 320 whether the received additional stroke sequence input 405 matches a portion of or a complete stroke sequence of a character. According to embodiments, a determination may also be made to determine whether possible character matches of the first stroke sequence 510 and one or more additional stroke sequences 510 may match one or more phrases. Phrase candidates 705A-D may be provided in the candidate line 210 (OPERATION 325) as illustrated in FIG. 7. For example, character candidates 240E-K may be determined for the received stroke sequence input 405A-C and character candidates may be determined upon receiving the second stroke sequence input 405D-F. Phrase candidates 705A-D may then be predicted by determining possible phrases that comprise one of the first character candidates 240E-K followed by one of the second character candidates.

The method 300 may proceed to OPERATION 330, where an indication of a selection of a candidate 240,705 is received. For example and as illustrated in FIG. 7, the user may select phrase candidate “ [symbol] ” 705C (translated into English as “minimum”), which is comprised of two characters, a portion of the first character matching the first stroke sequence 510 and a portion of the second character matching the second stroke sequence 510.

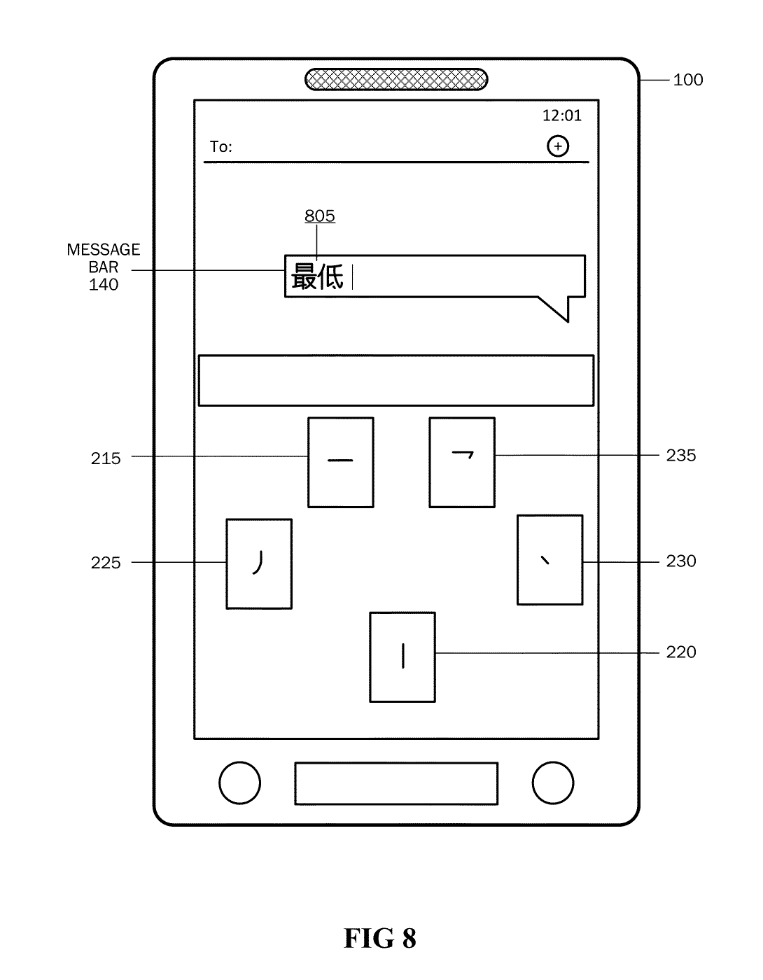

The method 300 may proceed to OPERATION 335, where the selected candidate 805 may be displayed in the message bar 140 as illustrated in FIG. 8. According to an embodiment, if only one candidate 240,705 is determined at DECISION OPERATION 320, the candidate 240,705 may be automatically displayed in the message bar 140. The method 300 ends at OPERATION 395.

Embodiments of the present invention also provide for continuous handwriting. As described briefly above, while current Chinese handwriting engine recognition rates are very high, unwanted delays may be experienced while a determination is made whether a handwriting input is complete. For example, a user may “write” a character on an interface 205 via one of various input methods. The user may then experience a delay while a handwriting engine determines whether the user has finished writing the character. Embodiments provide for continuous handwriting, allowing a user to input a plurality of characters without having to wait after inputting each character. Embodiments also provide for allowing a user to edit a recognized character.

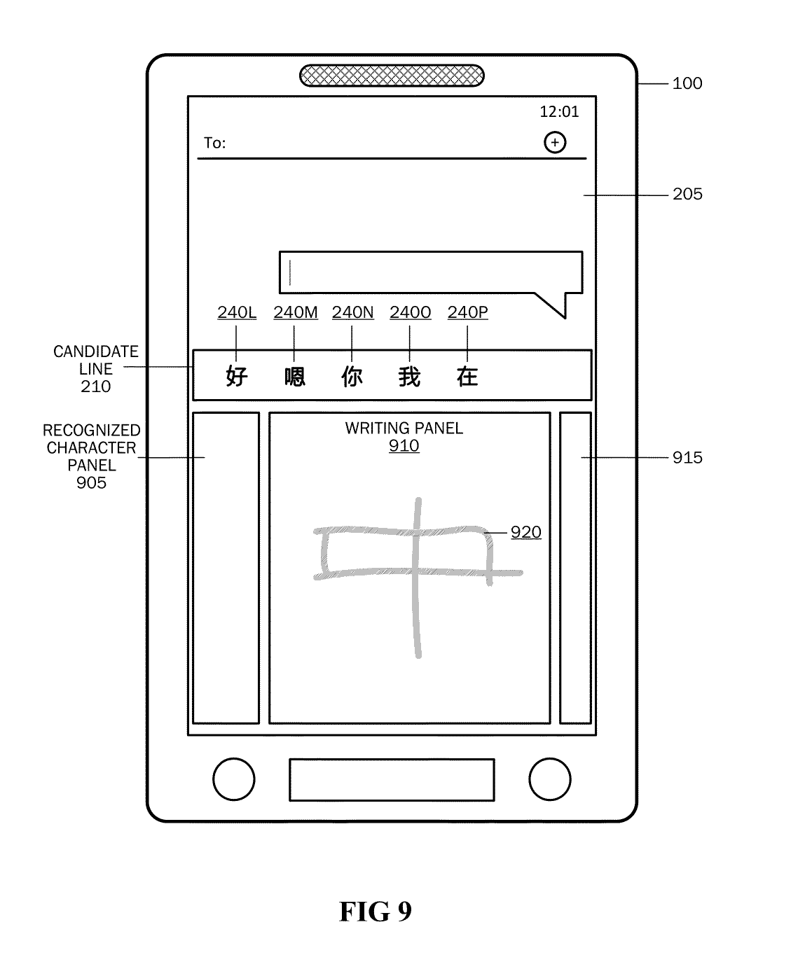

Referring now to FIG. 9, a GUI for continuous handwriting is illustrated. The GUI is shown displayed on a display interface 205 and may comprise a writing panel 910 within which a handwriting input 920 may be received. According to embodiments, a handwriting input 920 may comprise one or more strokes, for example, touch strokes made by a user via touching a touchscreen interface 205 via a finger, a stylus, or other input device. A handwriting input 920 may be made via other input methods, for example, gesture or via a mouse or other type of input device. According to embodiments, an “end-of-input” selector 915, herein referred to as an EOI selector 915, may be provided. When a selection of the EOI selector 915 is made, an indication is received that the current handwriting input 920 is complete.

Embodiments may also provide for character correction. As illustrated in FIG. 9, a recognized character panel 905 may be included. According to embodiments, when an indication is received that a current handwriting input 920 is complete, the handwriting input 920 may be recognized as a character and may be shown in the recognized character panel 905. If an error was made when inputting the handwriting input 920 or if the handwriting input 920 is incorrectly recognized, embodiments provide for allowing the user to select the character from the recognized character panel 905, wherein the character may be redisplayed in the writing panel 910. The user may then rewrite the character or select a candidate 240 from the candidate line 210.

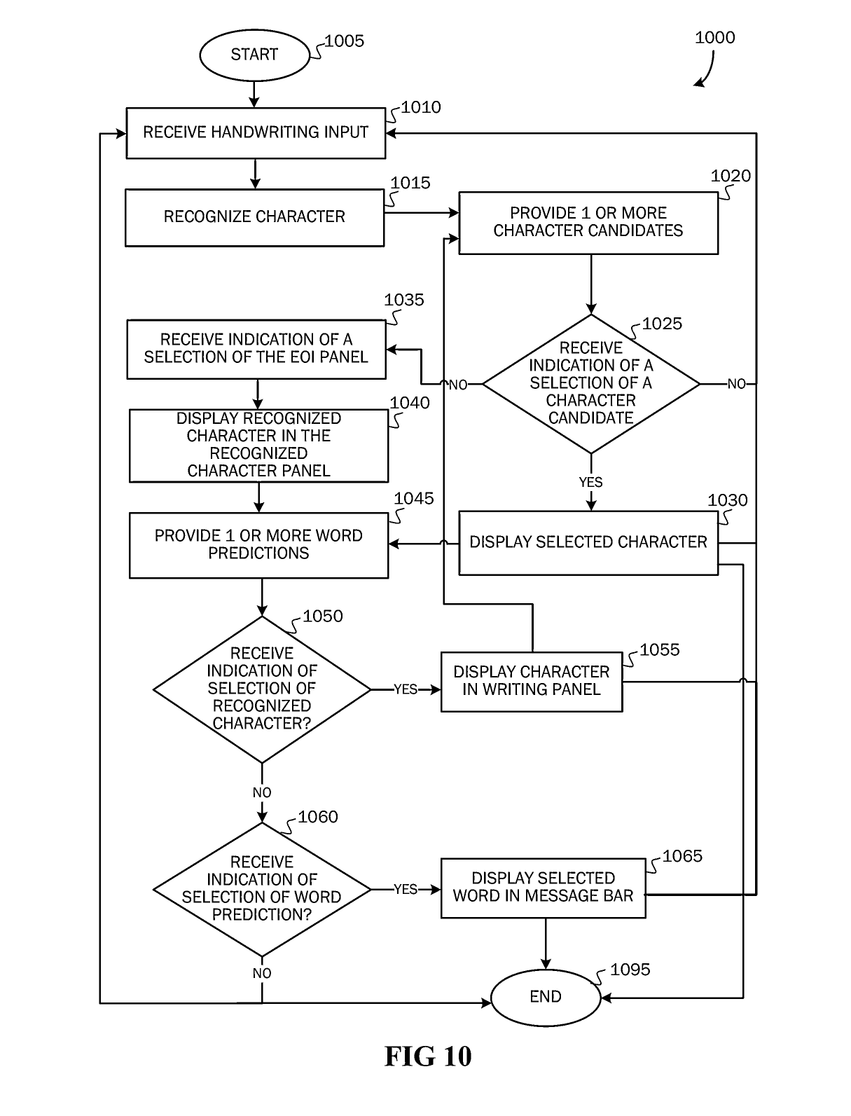

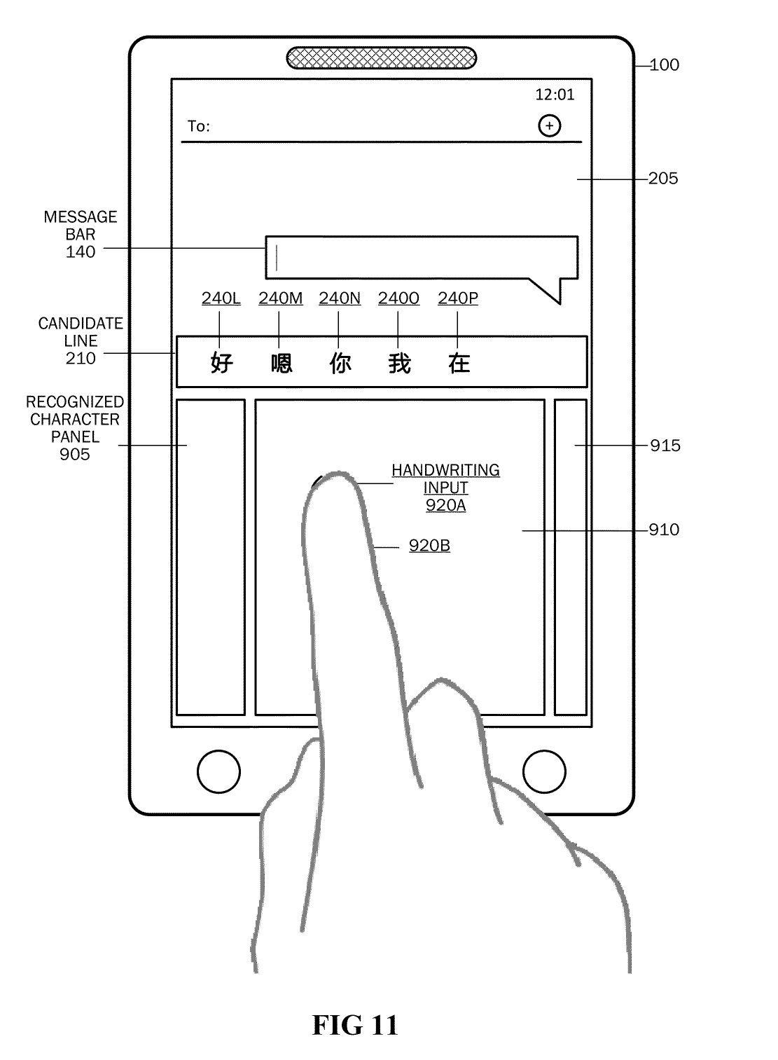

Referring now to FIG. 10, a flow chart of a method 1000 for providing continuous writing is illustrated. For purposes of illustration, the process flow of method 1000 will be described with reference to FIGS. 11-17. The method 1000 starts at OPERATION 1005 and proceeds to OPERATION 1010 where a handwriting input 920 is received. Handwriting input 920 may be received when a dynamic representation of handwriting is received within the writing panel 910. For example, a user may use his finger or a digital pen, stylus, a gesture, or other input device to input one or more strokes of a character. Movements of the input device may be interpreted and translated into a digital character.

An example of a user using his finger to enter handwriting input 920 into a writing panel 910 displayed on a display interface 205 of a mobile computing device 100 is illustrated in FIG. 11. As shown, the display interface 205 may include a touchscreen. The handwriting input 920 may be received when the user touches the screen (920A) within the writing panel 910 and subsequently makes one or more strokes (920B) associated with writing a character.

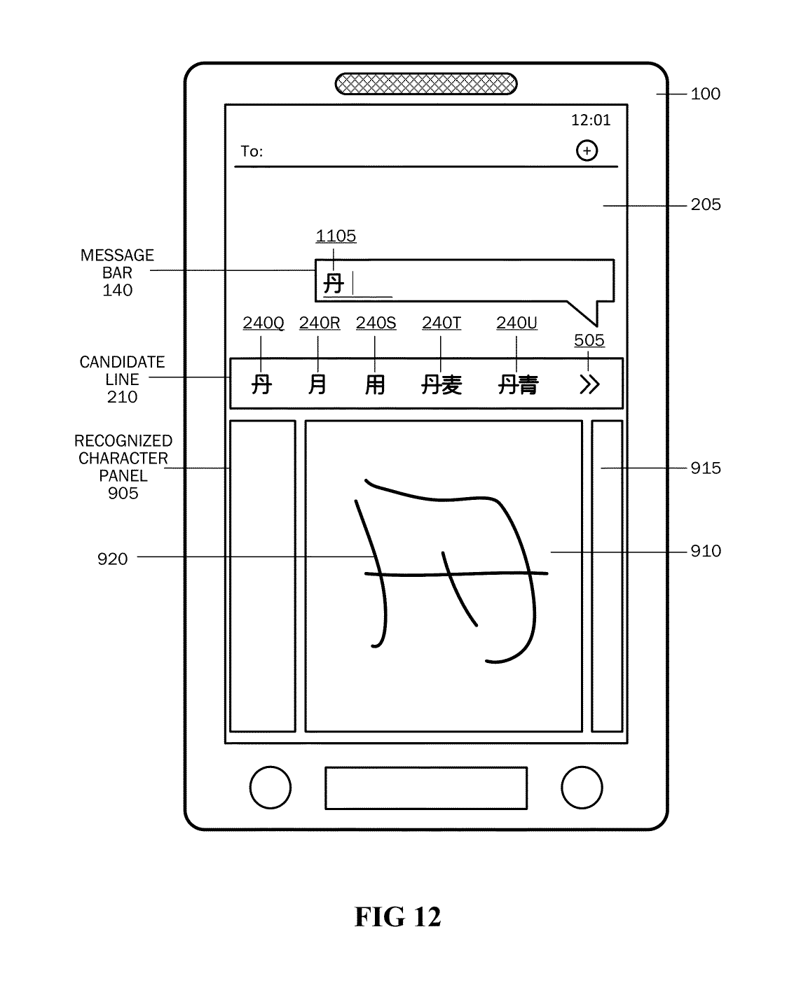

Referring back to FIG. 10, the method 1000 may proceed to OPERATION 1015, where the received handwriting input 920 is recognized as matching one or more possible characters. The method 1000 proceeds to OPERATION 1020, where one or more candidates 920 may be provided. As illustrated in FIG. 12, the handwriting input 920 entered by the user is shown in the writing panel 910. The handwriting input 920 may be recognized, and one or more candidates 240 determined as possible matches to the handwriting input 920 may be provided in the candidate line 210. According to an embodiment, a most-likely character candidate, herein referred to as a recognized character 1105, may be automatically displayed in the message bar 140.

With reference back to FIG. 10, the method may proceed to DECISION OPERATION 1025, where a determination is made whether an indication of a selection of a character candidate 240 is received. If an indication of a selection of a character candidate 240 is received, the method 1000 may proceed to OPERATION 1030, where the selected candidate 240 may replace the recognized character 1105 in the message bar 140. The method 1000 may then return to OPERATION 1010, where another handwriting input 920 associated with a next character is received. Alternatively, if no additional handwriting input 920 is received, the method 1000 may end at OPERATION 1095.

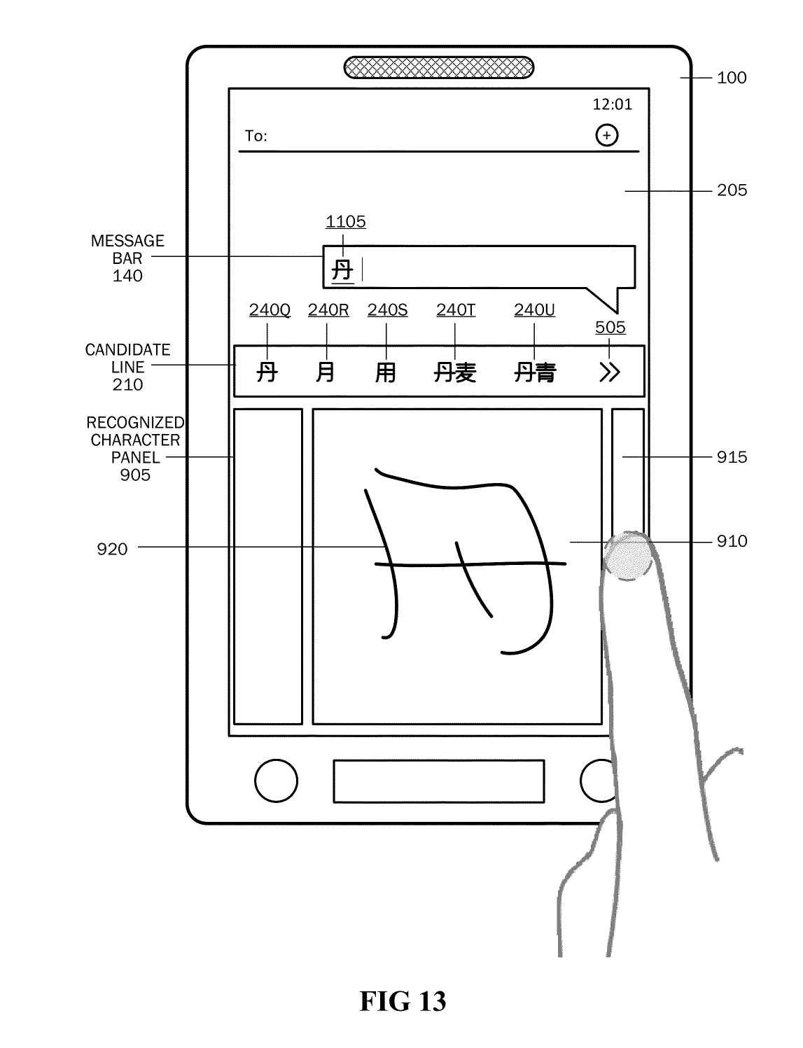

If at DECISION OPERATION 1025 an indication of a selection of a character candidate 240 is not received, the method 1000 may return to OPERATION 1010 where addition handwriting input 920 is received or may proceed to OPERATION 1035 where an indication of a selection of the EOI selector 915 is received. The EOI selector 915 may be selected via a touch or other input device selection of the EOI selector 915 as illustrated in FIG. 13, or via a swipe or flick of the EOI selector 915 to the left.

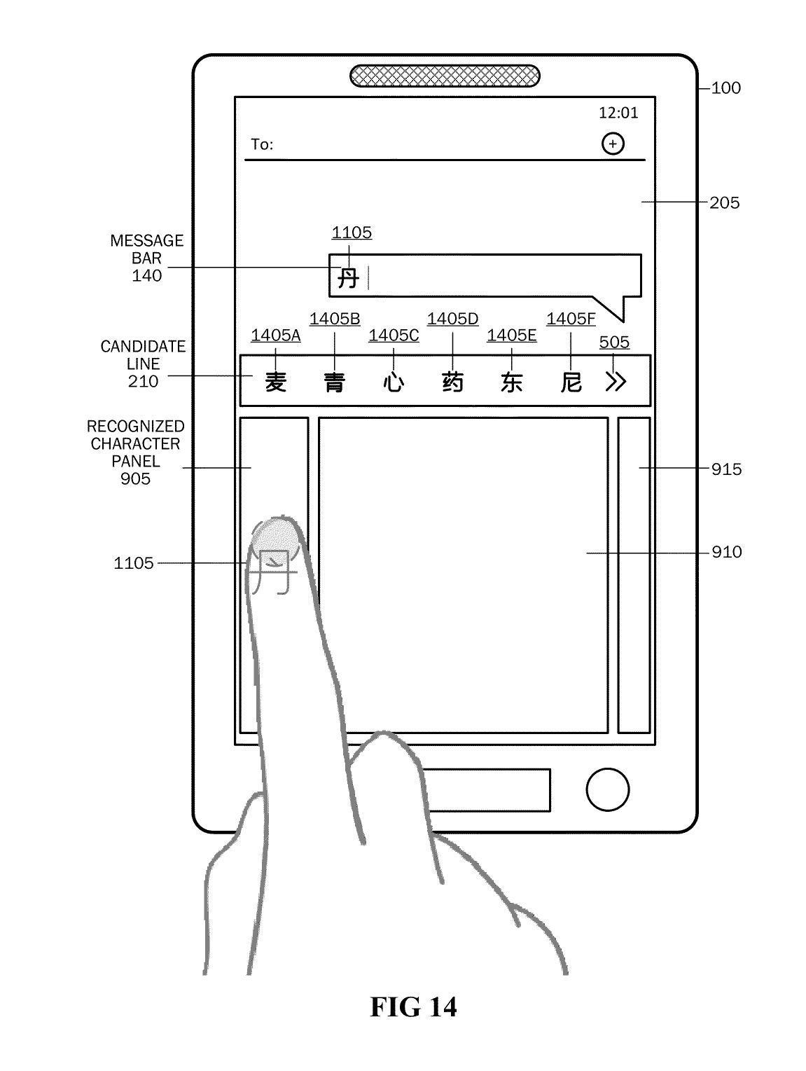

After an indication of a selection of the EOI selector 915 is received, the method 1000 may proceed to OPERATION 1040, where the recognized character 1105 may be displayed in the recognized character panel 905. According to embodiments, the recognized character panel 905 may allow a user to select a recognized character 1105 and edit or correct the recognized character if desired. The method 1000 may then proceed to OPERATION 1045, where one or more word predictions 1405 may be displayed in the candidate line 210 (illustrated in FIG. 14). The one or more word predictions 1405 may be determined according probabilities of word matches according to one or more recognized characters 1105.

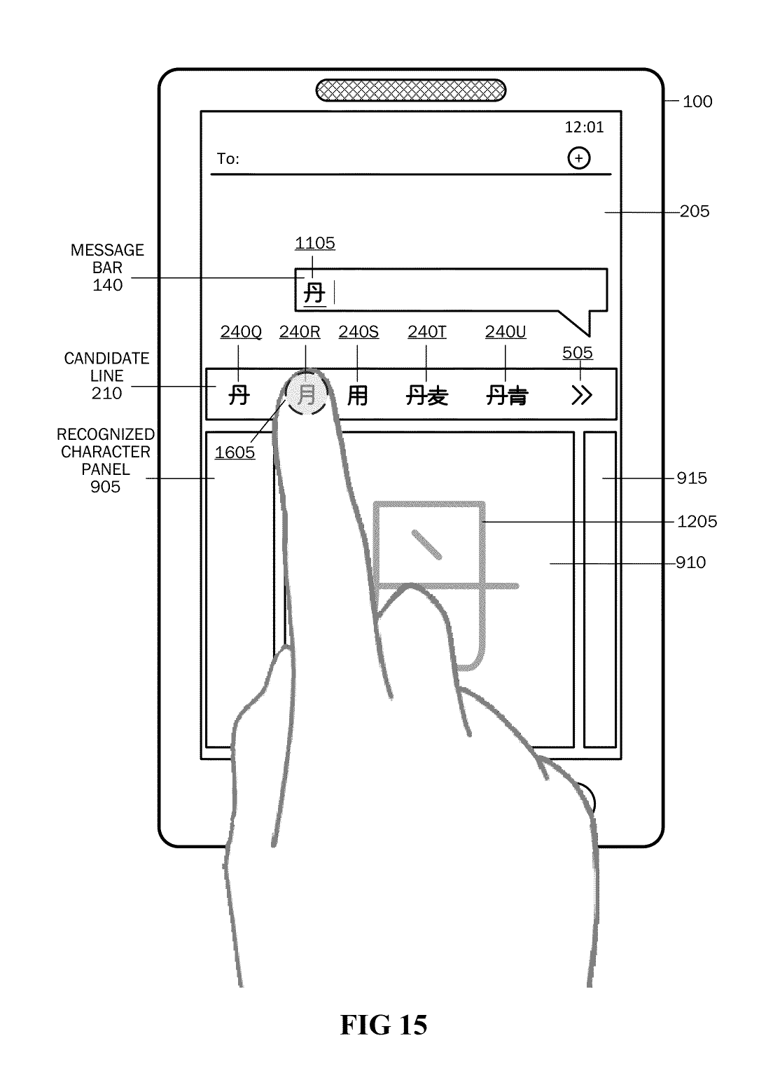

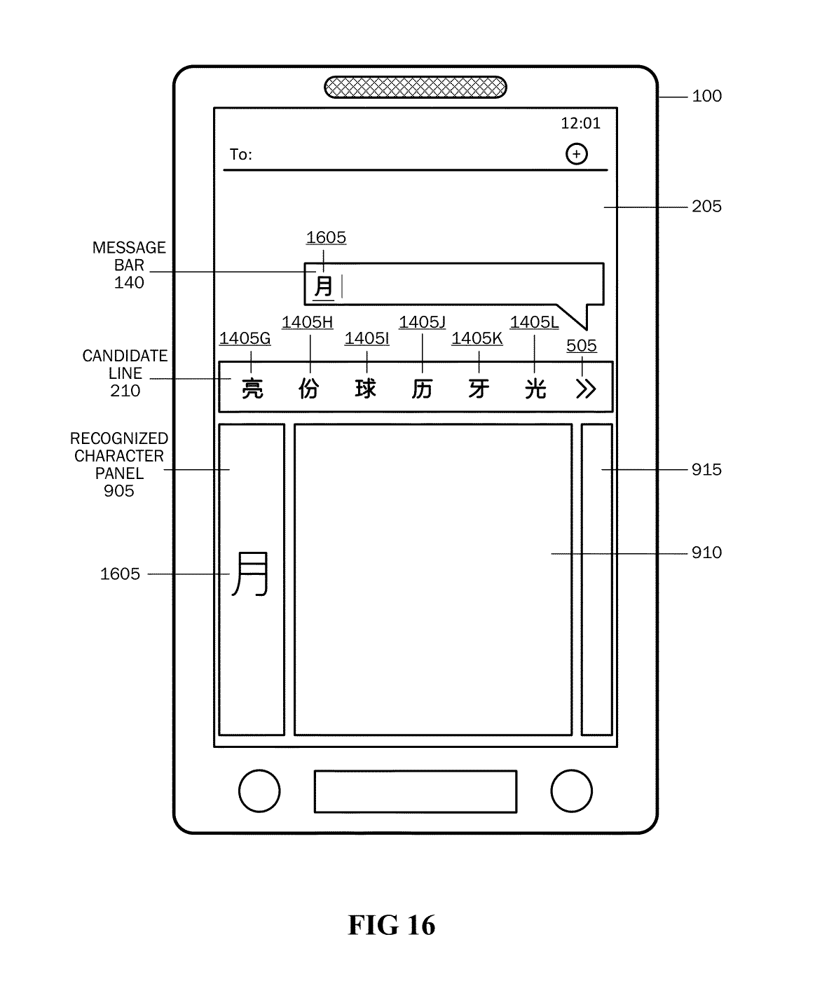

The method 1000 may proceed to DECISION OPERATION 1050, where a determination is made whether the recognized character 1105 displayed in the recognized character panel 905 is selected. If the recognized character 1105 displayed in the recognized character panel 905 is selected (illustrated in FIG. 14), the method 1000 may proceed to OPERATION 1055, where the recognized character 1105 may be redisplayed in the writing panel 910. According to embodiments, the user may edit or correct the handwriting input 920. The method 1000 may return to OPERATION 1010 if the user chooses to make changes to the handwriting input 920. Alternatively, the method 1000 may return to OPERATION 1020, where one or more character candidates 240 may be redisplayed in the candidate line 210. The user may select a character candidate 240 as illustrated in FIG. 15. If a character candidate 240 is selected, the selected character 1605 may replace the recognized character 1105 displayed in the message bar 140 (OPERATION 1030) as illustrated in FIG. 16. Additionally, the selected character 1605 may be displayed in the recognized character panel 905. The method 1000 may proceed to OPERATION 1045, where one or more word predictions 1405 may be determined and provided. The one or more word predictions 1405 may be determined according to a probability based on the selected character 1605.

Referring again to FIG. 10, if the recognized character 1105 displayed in the recognized character panel 905 is not selected at DECISION OPERATION 1050, the method 1000 may proceed to DECISION OPERATION 1060 where a determination may be made whether an indication of a selection of a word prediction 1405 is received. If an indication of a selection of a word prediction 1405 is received, the method 1000 may proceed to OPERATION 1065 where the selected word prediction 1405 may be displayed in the message bar 140. The method 1000 may end at OPERATION 1095 or may return to OPERATION 1010, where additional handwriting input 920 may be received.

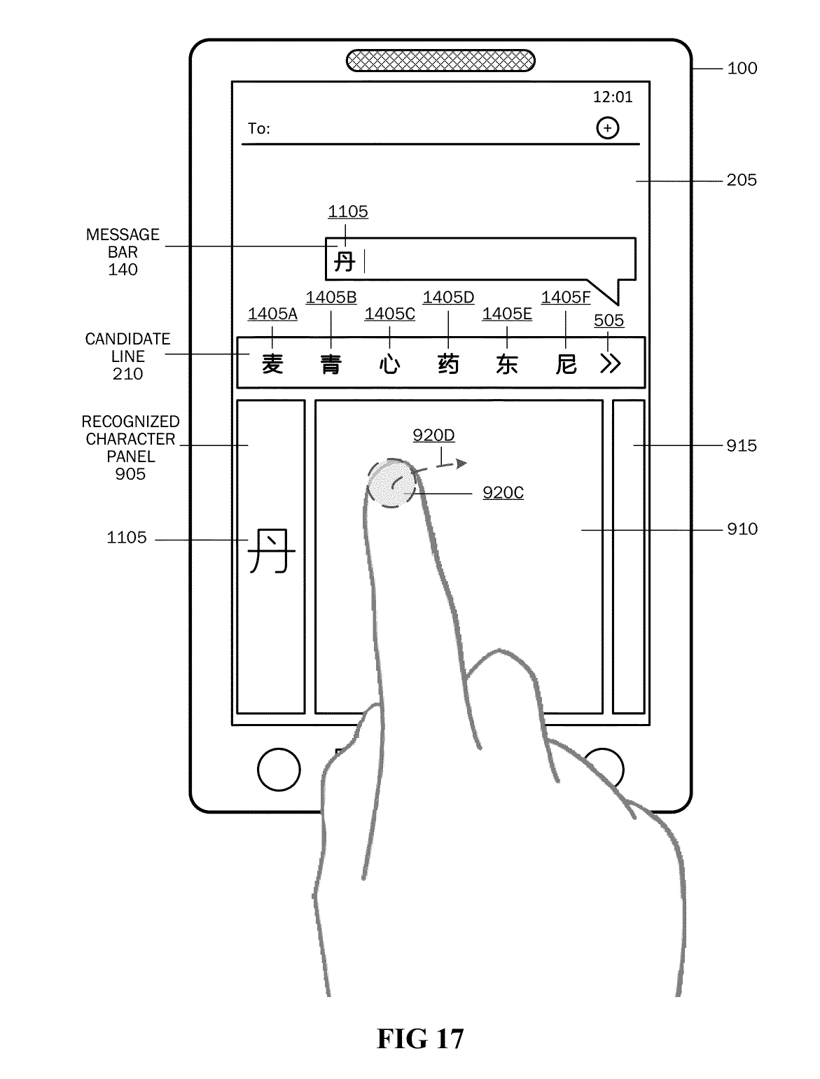

If an indication of a selection of a word prediction 1405 is not received at DECISION OPERATION 1060, the method 1000 may return to OPERATION 1010, where additional handwriting input 920 may be received (as illustrated in FIG. 17), or may end at OPERATION 1095.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, IP phones, gaming devices, multiprocessor systems, microprocessor-based or programmable consumer electronics, minicomputers, and mainframe computers. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected.

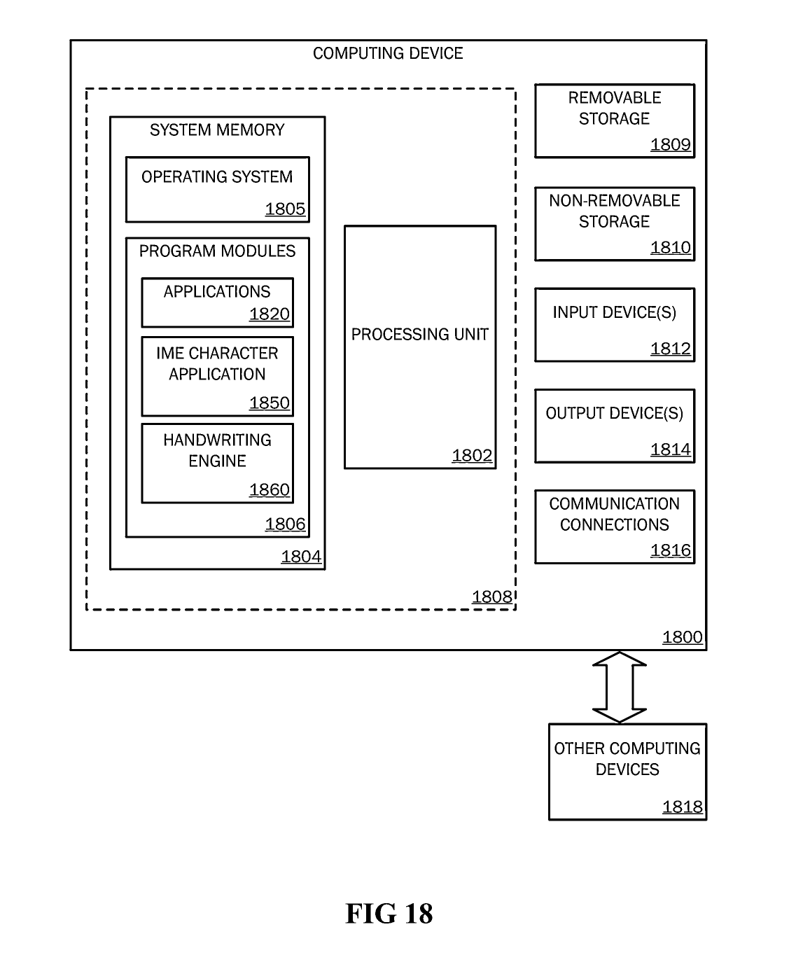

Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. As described above, gesture entry may also include an input made with a mechanical input device (e.g., with a mouse, touchscreen, stylus, etc.), the input originating from a bodily motion that can be received, recognized, and translated into a selection and/or movement of an element or object on a graphical user interface that mimics the bodily motion. FIGS. 18 through 20 and the associated descriptions provide a discussion of a variety of operating environments in which embodiments of the invention may be practiced. However, the devices and systems illustrated and discussed with respect to FIGS. 18 through 20 are for purposes of example and illustration and are not limiting of a vast number of computing device configurations that may be utilized for practicing embodiments of the invention, described herein.

FIG. 18 is a block diagram illustrating example physical components (i.e., hardware) of a computing device 1800 with which embodiments of the invention may be practiced. The computing device components described below may be suitable for the computing devices described above. In a basic configuration, the computing device 1800 may include at least one processing unit 1802 and a system memory 1804. Depending on the configuration and type of computing device, the system memory 1804 may comprise, but is not limited to, volatile storage (e.g., random access memory), non-volatile storage (e.g., read-only memory), flash memory, or any combination of such memories. The system memory 1804 may include an operating system 1805 and one or more program modules 1806 suitable for running software applications 1820 such as an IME Character Application 1850 and/or a Handwriting Engine 1860. The operating system 1805, for example, may be suitable for controlling the operation of the computing device 1800. Furthermore, embodiments of the invention may be practiced in conjunction with a graphics library, other operating systems, or any other application program and is not limited to any particular application or system. This basic configuration is illustrated in FIG. 18 by those components within a dashed line 1808. The computing device 1800 may have additional features or functionality. For example, the computing device 1800 may also include additional data storage devices (removable and/or non-removable) such as, for example, magnetic disks, optical disks, or tape. Such additional storage is illustrated in FIG. 18 by a removable storage device 1809 and a non-removable storage device 1810.

As stated above, a number of program modules and data files may be stored in the system memory 1804. While executing on the processing unit 1802, the program modules 1806, such as the IME Character Application 1850 or the Handwriting Engine 1860 may perform processes including, for example, one or more of the stages of methods 300 and 1000. The aforementioned processes are examples, and the processing unit 1802 may perform other processes. Other program modules that may be used in accordance with embodiments of the present invention may include electronic mail and contacts applications, word processing applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 18 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the IME Character Application 1850 and/or the Handwriting Engine 1860 may be operated via application-specific logic integrated with other components of the computing device 1800 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1800 may also have one or more input device(s) 1812 such as a keyboard, a mouse, a pen, a sound input device, a touch input device, a microphone, a gesture recognition device, etc. The output device(s) 1814 such as a display, speakers, a printer, etc. may also be included. The aforementioned devices are examples and others may be used. The computing device 1800 may include one or more communication connections 1816 allowing communications with other computing devices 1818. Examples of suitable communication connections 1816 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 1804, the removable storage device 1809, and the non-removable storage device 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 1800. Any such computer storage media may be part of the computing device 1800.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

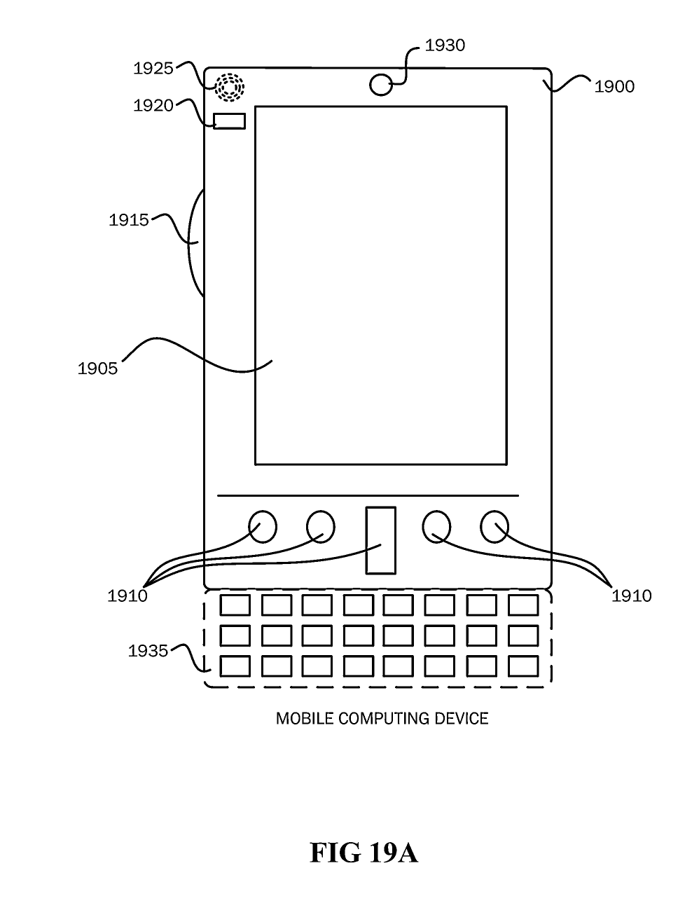

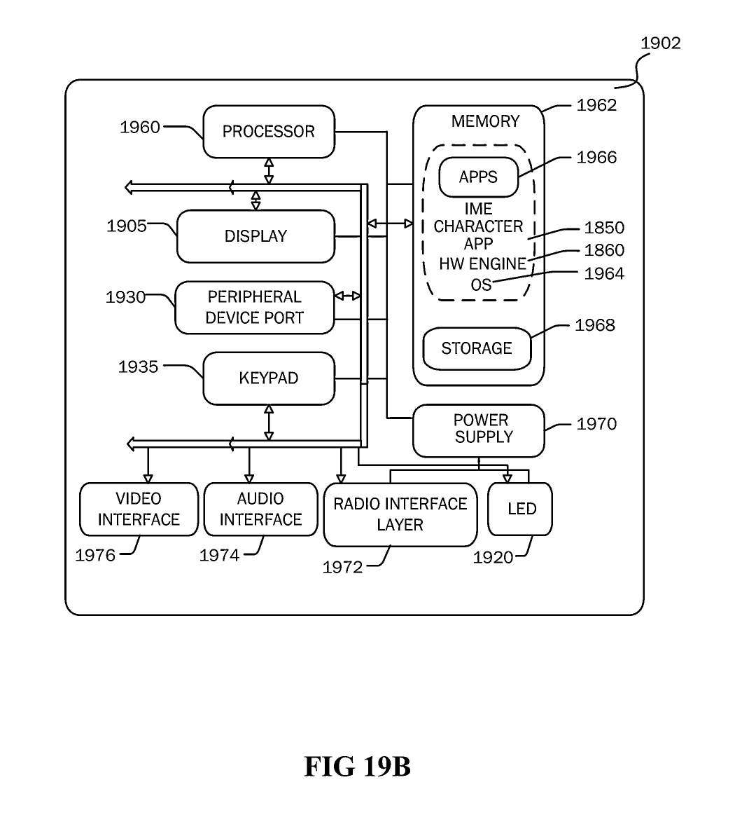

FIGS. 19A and 19B illustrate a mobile computing device 1900, for example, a mobile telephone 100, a smart phone, a tablet personal computer 200, a laptop computer, and the like, with which embodiments of the invention may be practiced. With reference to FIG. 19A, an exemplary mobile computing device 1900 for implementing the embodiments is illustrated. In a basic configuration, the mobile computing device 1900 is a handheld computer having both input elements and output elements. The mobile computing device 1900 typically includes a display 1905 and one or more input buttons 1910 that allow the user to enter information into the mobile computing device 1900. The display 1905 of the mobile computing device 1900 may also function as an input device (e.g., a touch screen display). If included, an optional side input element 1915 allows further user input. The side input element 1915 may be a rotary switch, a button, or any other type of manual input element. In alternative embodiments, mobile computing device 1900 may incorporate more or less input elements. For example, the display 1905 may not be a touch screen in some embodiments. In yet another alternative embodiment, the mobile computing device 1900 is a portable phone system, such as a cellular phone. The mobile computing device 1900 may also include an optional keypad 1935. Optional keypad 1935 may be a physical keypad or a “soft” keypad generated on the touch screen display. In various embodiments, the output elements include the display 1905 for showing a graphical user interface (GUI), a visual indicator 1920 (e.g., a light emitting diode), and/or an audio transducer 1925 (e.g., a speaker). In some embodiments, the mobile computing device 1900 incorporates a vibration transducer for providing the user with tactile feedback. In yet another embodiment, the mobile computing device 1900 incorporates input and/or output ports, such as an audio input (e.g., a microphone jack), an audio output (e.g., a headphone jack), and a video output (e.g., a HDMI port) for sending signals to or receiving signals from an external device.

FIG. 19B is a block diagram illustrating the architecture of one embodiment of a mobile computing device. That is, the mobile computing device 1900 can incorporate a system (i.e., an architecture) 1902 to implement some embodiments. In one embodiment, the system 1902 is implemented as a “smart phone” capable of running one or more applications (e.g., browser, e-mail, calendaring, contact managers, messaging clients, games, and media clients/players). In some embodiments, the system 1902 is integrated as a computing device, such as an integrated personal digital assistant (PDA) and wireless phone.

One or more application programs 1966 may be loaded into the memory 1962 and run on or in association with the operating system 1964. Examples of the application programs include phone dialer programs, e-mail programs, personal information management (PIM) programs, word processing programs, spreadsheet programs, Internet browser programs, messaging programs, and so forth. The system 1902 also includes a non-volatile storage area 1968 within the memory 1962. The non-volatile storage area 1968 may be used to store persistent information that should not be lost if the system 1902 is powered down. The application programs 1966 may use and store information in the non-volatile storage area 1968, such as e-mail or other messages used by an e-mail application, and the like. A synchronization application (not shown) also resides on the system 1902 and is programmed to interact with a corresponding synchronization application resident on a host computer to keep the information stored in the non-volatile storage area 1968 synchronized with corresponding information stored at the host computer. As should be appreciated, other applications may be loaded into the memory 1962 and run on the mobile computing device 1900, including the IME Character Application 1850 and/or the Handwriting Engine 1860 described herein.

The system 1902 has a power supply 1970, which may be implemented as one or more batteries. The power supply 1970 might further include an external power source, such as an AC adapter or a powered docking cradle that supplements or recharges the batteries. The system 1902 may also include a radio 1972 that performs the function of transmitting and receiving radio frequency communications. The radio 1972 facilitates wireless connectivity between the system 1902 and the “outside world”, via a communications carrier or service provider. Transmissions to and from the radio 1972 are conducted under control of the operating system 1964. In other words, communications received by the radio 1972 may be disseminated to the application programs 1966 via the operating system 1964, and vice versa.

The radio 1972 allows the system 1902 to communicate with other computing devices, such as over a network. The radio 1972 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 1902 provides notifications using the visual indicator 1920 that can be used to provide visual notifications and/or an audio interface 1974 producing audible notifications via the audio transducer 1925. In the illustrated embodiment, the visual indicator 1920 is a light emitting diode (LED) and the audio transducer 1925 is a speaker. These devices may be directly coupled to the power supply 1970 so that when activated, they remain on for a duration dictated by the notification mechanism even though the processor 1960 and other components might shut down for conserving battery power. The LED may be programmed to remain on indefinitely until the user takes action to indicate the powered-on status of the device. The audio interface 1974 is used to provide audible signals to and receive audible signals from the user. For example, in addition to being coupled to the audio transducer 1925, the audio interface 1974 may also be coupled to a microphone to receive audible input, such as to facilitate a telephone conversation. In accordance with embodiments of the present invention, the microphone may also serve as an audio sensor to facilitate control of notifications, as will be described below. The system 1902 may further include a video interface 1976 that enables an operation of an on-board camera 1930 to record still images, video stream, and the like.

A mobile computing device 1900 implementing the system 1902 may have additional features or functionality. For example, the mobile computing device 1900 may also include additional data storage devices (removable and/or non-removable) such as, magnetic disks, optical disks, or tape. Such additional storage is illustrated in FIG. 19B by the non-volatile storage area 1968. Computer storage media may include volatile and nonvolatile, removable and non-removable media implemented in any method or technology for storage of information, such as computer readable instructions, data structures, program modules, or other data.

Data/information generated or captured by the mobile computing device 1900 and stored via the system 1902 may be stored locally on the mobile computing device 1900, as described above, or the data may be stored on any number of storage media that may be accessed by the device via the radio 1972 or via a wired connection between the mobile computing device 1900 and a separate computing device associated with the mobile computing device 1900, for example, a server computer in a distributed computing network, such as the Internet. As should be appreciated such data/information may be accessed via the mobile computing device 1900 via the radio 1972 or via a distributed computing network. Similarly, such data/information may be readily transferred between computing devices for storage and use according to well-known data/information transfer and storage means, including electronic mail and collaborative data/information sharing systems.

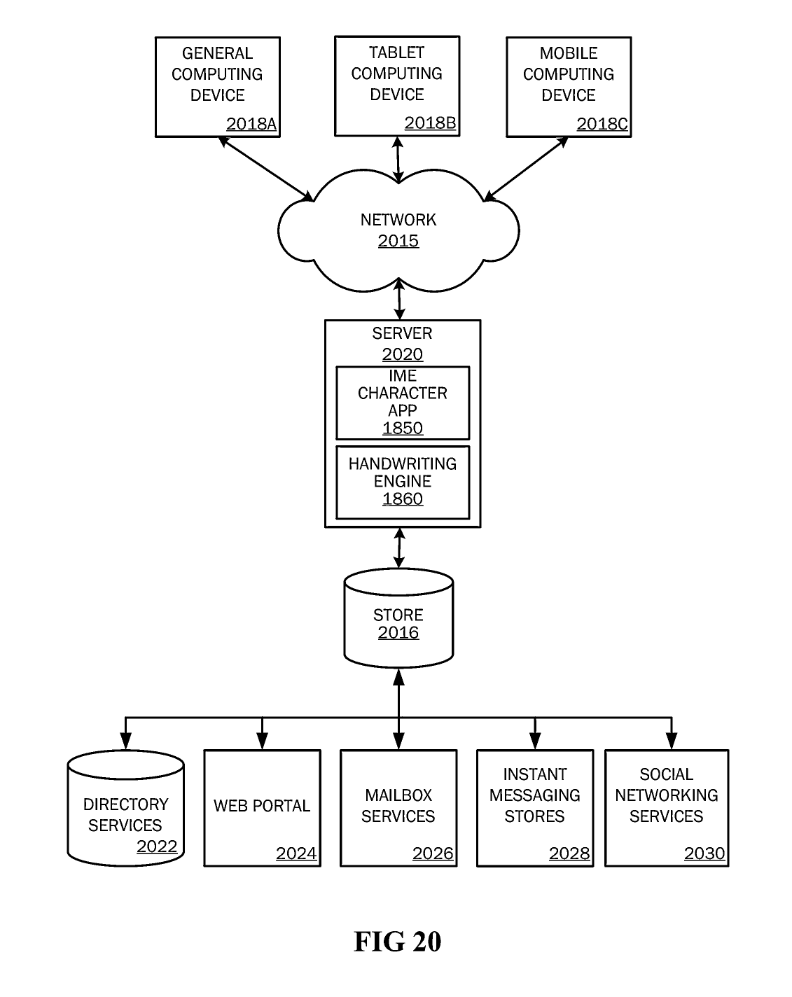

FIG. 20 illustrates one embodiment of the architecture of a system for providing the IME Character Application 1850 and/or a Handwriting Engine 1860 to one or more client devices, as described above. Content developed, interacted with or edited in association with the IME Character Application 1850 and/or a Handwriting Engine 1860 may be stored in different communication channels or other storage types. For example, various documents may be stored using a directory service 2022, a web portal 2024, a mailbox service 2026, an instant messaging store 2028, or a social networking site 2030. IME Character Application 1850 and/or a Handwriting Engine 1860 may use any of these types of systems or the like for providing swipe stroke input and continuous handwriting, as described herein. A server 2020 may provide the IME Character Application 1850 and/or a Handwriting Engine 1860 to clients. As one example, the server 2020 may be a web server providing the IME Character Application 1850 and/or a Handwriting Engine 1860 over the web. The server 2020 may provide the IME Character Application 1850 and/or a Handwriting Engine 1860 over the web to clients through a network 2015. By way of example, the client computing device 2018 may be implemented as the computing device 1800 and embodied in a personal computer 2018a, a tablet computing device 2018b and/or a mobile computing device 2018c (e.g., a smart phone). Any of these embodiments of the client computing device 2018 may obtain content from the store 2016. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method for providing swipe-stroke input of Chinese text, the method comprising:
receiving a stroke sequence input via receiving an indication of a selection of one or more stroke buttons;
determining one or more character candidates according to the received stroke sequence input;
determining if an indication of a selection of a character candidate is received;
when an indication of a selection of a character candidate is received, displaying the selected character candidate; and
when an indication of a selection of a character candidate is not received, receiving a next stroke sequence input and determining one or more candidate phrases according to the received stroke sequence inputs.

2. The method of claim 1, wherein receiving a stroke sequence input comprises receiving a complete or a portion of a character stroke sequence.

3. The method of claim 1, further comprising displaying a plurality of stroke buttons and wherein displaying a plurality of stroke buttons comprises displaying a plurality of stroke buttons on a touchscreen interface.

4. The method of claim 3, wherein receiving a stroke sequence input via receiving an indication of a selection of one or more stroke buttons comprises receiving an indication of a selection of one or more stroke buttons via a swipe-stroke gesture.

5. The method of claim 4, wherein prior to determining one or more character candidates according to the received stroke sequence input, receiving an indication of an end of a stroke sequence input.

6. The method of claim 5, wherein receiving an indication of an end of a stroke sequence input comprises determining when a user's finger is lifted from the touchscreen interface.

7. The method of claim 1, wherein the plurality of stroke buttons comprise a horizontal stroke button, a vertical stroke button, a downwards right-to-left stroke button, a dot or downwards left-to-right stroke button, and an all-other stroke button.

8. The method of claim 1, wherein after determining one or more candidate phrases according to the received stroke sequence inputs:
displaying the one or more candidate phrases;
receiving a selection of a candidate phrase; and
displaying the selected candidate phrase.

9. A method for providing continuous handwriting of Chinese text, the method comprising:
receiving a first handwriting input;
recognizing the first handwriting input as a first character;
receiving an indication of a selection of an end-of-input panel indicating an end of handwriting input for the first character;
receiving a second handwriting input; and
determining and displaying one or more word predictions according to received handwriting inputs.

10. The method of claim 9, further comprising providing a recognized character panel and displaying a recognized character in the recognized character panel.

11. The method of claim 10, further comprising receiving a selection of the recognized character and allowing editing of the handwriting input associated with the recognized character.

12. The method of claim 9, wherein receiving a first handwriting input comprises receiving a first handwriting input via a touchscreen interface.

13. The method of claim 12, wherein receiving an indication of a selection of an end of input panel comprises receiving an indication of a touch within the end-of-input panel.

14. The method of claim 12, wherein receiving an indication of a selection of an end-of-input panel comprises receiving an indication of a swipe gesture originating in the end of input panel.

15. The method of claim 9, further comprising prior to receiving a second handwriting input, determining and displaying one or more character candidates according to the first received handwriting input.

16. The method of claim 9, further comprising receiving a selection of a word prediction and displaying the selected word prediction.

17. A system for providing swipe-stroke input and continuous handwriting of Chinese text, the system comprising:
a memory storage; and
a processing unit coupled to the memory storage, wherein the processing unit is operable to:
display a plurality of stroke buttons;
receive a stroke sequence input via receiving an indication of a selection of one or more stroke buttons;
determine one or more character candidates according to the received stroke sequence input;
determine if an indication of a selection of a character candidate is received;
when an indication of a selection of a character candidate is received, display the selected character candidate;
when an indication of a selection of a character candidate is not received, receive a next stroke sequence input and determine one or more candidate phrases according to the received stroke sequence inputs;
receive a first handwriting input;
recognize the first handwriting input as a first character;
receive an indication of a selection of an end-of-input panel indicating an end of handwriting input for the first character;
receive a second handwriting input; and
determine and display one or more word predictions according to received handwriting inputs.

18. The system of claim 17, further comprising a touchscreen interface operable to receive input.

19. The system of claim 17, wherein the processor is further operable to:
provide a recognized character panel; and
displaying a recognized character in the recognized character panel.

20. The system of claim 19, wherein the processor is further operable to:
receive a selection of the recognized character; and
allow editing of the handwriting input associated with the recognized character.
